(19) United States
(12) Patent Application Publication
(10) Pub. No.: US 2025/0321144 A1
(43) Pub. Date: Oct. 16, 2025

(54) THERMOCOUPLE SENSORS AND RELATED METHODS

(71) Applicant: Aircom Instrumentation Ltd., Edmonton (CA)

(72) Inventors: Brandon ST.GERMAIN, Edmonton (CA); Corey WINKELMANN, Edmonton (CA); Micheal TAYLER, Edmonton (CA); Mirela PACHITA, Edmonton (CA); Richard HAYS, Edmonton (CA); Sean LAVIN, Edmonton (CA)

(21) Appl. No.: 19/179,981

(22) Filed: Apr. 15, 2025

Related U.S. Application Data
(60) Provisional application No. 63/634,287, filed on Apr. 15, 2024.

(51) Int. Cl. G01K 7/02; G01K 1/14

(52) U.S. Cl. CPC G01K 7/023; G01K 1/14

(57) ABSTRACT

A thermocouple sensor includes a sensor block having first and second ends, the sensor block defining an inner chamber. The sensor block comprises a first passage extending from the first end of the sensor block to the inner chamber, and a second passage extending from the inner chamber to an outer surface of the sensor block. The sensor also comprises a pair of conductive wires extending through the first passage into the inner chamber of the sensor block and extending into second passage from the inner chamber, the pair of conductive wires coupled together to form a thermocouple junction. The thermocouple junction may extend at least partially out from the second passage.

### RELATED APPLICATION

The present application claims priority to U.S. Provisional Patent Application No. 63/634,287, filed Apr. 15, 2024, the entire contents of which are incorporated herein by reference.

### FIELD OF THE DISCLOSURE

The present application relates to thermocouple sensors. More particularly, the application relates to thermocouple couple sensors that may be coupled to an object, such as a pipe or other tubular, for temperature sensing.

### BACKGROUND

A thermocouple sensor may be coupled to an object, such as a pipe, for measuring the temperature of that object. A thermocouple sensor may, for example, be welded to the outer surface of the pipe. An example thermocouple sensor is described in U.S. Pat. No. 7,789,555, the entire contents of which are incorporated herein by reference.

A thermocouple sensor may comprise a “hot” junction formed by a pair of wires of dissimilar metal that are joined together. A voltage across the junction may vary as a function of temperature of the junction. Thus, temperature of the object to which the sensor is attached may be sensed. Prior existing thermocouple sensors may include a thermocouple junction formed from a pair of wires that is welded directly to a pipe or other object to be measured. However, there is a need for thermocouple sensors having improved accuracy and heat stability.

In prior sensors, the hot junction may be located in a tucked away position that it requires welding to fully penetrate a sensor block and/or requires the sensor block to be aligned and clamped down prior to welding. Prior sensors may also be limited in the location of the hot junction.

### SUMMARY

According to an aspect of the disclosure, there is provided a thermocouple sensor comprising: a sensor block having first and second ends, the sensor block defining an inner chamber and comprising: a first passage extending from the first end of the sensor block to the inner chamber, a second passage extending from the inner chamber to an outer surface of the sensor block; and a pair of conductive wires extending through the first passage into the inner chamber of the sensor block and extending into second passage from the inner chamber, the pair of conductive wires being coupled together to form a thermocouple junction.

In some embodiments, the junction formed by the pair of conductive wires extends at least partially out from the second passage.

In some embodiments, the second passage extends from the inner chamber to a passage opening defined in the outer surface of the sensor block, wherein the passage opening is located at or proximate to the second end of the sensor block.

In some embodiments, the second passage extends from the inner chamber to a passage opening defined in the outer surface of the sensor block, wherein the passage opening is located at or proximate to a side the sensor block

In some embodiments, the sensor block has a bottom face for mounting on an object, and the passage opening is positioned in the bottom face of the sensor block.

In some embodiments, second passage extends, from the inner chamber and to the passage opening, at a downward angle and toward the second end.

In some embodiments, the second passage extends from the inner chamber to the second end of the sensor block.

In some embodiments, the sensor comprises a cable, the cable comprising a cable sheath, at least the first and second conductive wires, and insulating material surrounding the conductive wires within the sheath, the first and second conductive wires having end portions extending from the sheath and insulating material, wherein the end portions of the first and second conductive wires are coupled to form the thermocouple junction.

In some embodiments, the cable sheath is received into the first passage, and the end portions of the first and second conductive wires extend into the second passage.

In some embodiments, the pair of conductive wires is a first pair of conductive wires, and the junction is a first junction, the thermocouple sensor further comprising: a third passage extending from the inner chamber to the outer surface of the sensor block; and a second pair of conductive wires extending into the sensor block through the first passage and into the third passage, the pair of wires forming a second thermocouple junction at least partially within the third passage.

In some embodiments, the sensor block has a bottom face, and the second and third passages extend from an inner surface of the inner chamber to second and third openings, respectively, at the bottom face of the sensor block.

In some embodiments, second and third passages extend, from the inner chamber and to the passage opening, at a downward angle and toward the second end.

In some embodiments, the second and third passages extend, from the inner chamber, toward opposite respective sides of the sensor block.

In some embodiments, the sensor block comprises a weld preparation region extending along a portion of the periphery of the sensor block adjacent the bottom face.

In some embodiments, the weld preparation comprises a tapered surface, the passage opening being located at least partially within or under the tapered surface.

In some embodiments, the sensor block defines one or more downward facing shoulders on at least one of the second end and first and second sides of the sensor block, and the thermocouple sensor further comprises a heatshield covering the sensor block.

In some embodiments, the first passage extends from the first end to the second end, the first passage defining the inner chamber.

In some embodiments, the sensor comprises a cable extending through the first passage and comprising first and second pairs of conductive wires, the cable comprising the pair of conductive wires extending into the second passage and forming the thermocouple junction, the cable further comprising a second pair of conductive wires that extend through the first passage and out from the first passage at the second end of the sensor block.

According to another aspect of the disclosure, there is provided a sensor block for a thermocouple sensor, the sensor block having first and second ends and defining an inner chamber, the sensor block comprising: a first passage extending from the first end of the sensor block to the inner chamber; and a second passage extending from the inner chamber to an outer surface of the sensor block and shaped to receive a pair of conductive wires forming a thermocouple junction at least partially within the second passage.

In some embodiments, the second passage extends from the inner chamber to a passage opening defined in the outer surface of the sensor block, wherein the passage opening is located at or proximate to the second end of the sensor block.

In some embodiments, the sensor block has a bottom face for mounting on an object, and the passage opening is positioned in the bottom face of the sensor block.

In some embodiments, second passage extends, from the inner chamber and to the passage opening, at a downward angle and toward the second end.

In some embodiments, the first passage is shaped to receive a cable comprising the pair of conductive wires.

In some embodiments, the sensor block further comprises a third passage extending from the inner chamber to the outer surface of the sensor block and shaped to receive a second pair of conductive wires forming a second thermocouple junction at least partially within the second passage.

In some embodiments the sensor block has a bottom face, and the second and third passages extend from the inner surface of the inner chamber to second and third openings, respectively, at the bottom face of the sensor block.

According to another aspect, there is provided a method comprising providing a sensor block, the sensor block having first and second ends and defining an inner chamber and comprising: a first passage extending from the first end of the sensor block to the inner chamber; and a second passage extending from the inner chamber to an outer surface of the sensor block; and inserting a pair of conductive wires through the first passage into the inner chamber of the sensor block and into second passage from the inner chamber, the pair of conductive wires being coupled together to form a thermocouple junction.

In some embodiments, the method further comprises welding the sensor block and thermocouple junction to a surface of an object to be measured.

According to another aspect, there is provided a method comprising assembling the sensor as described herein above or below.

According to another aspect, there is provided a method comprising using the sensor as described herein above or below to obtain one or more temperature measurements.

Other aspects and features of the present disclosure will become apparent to those ordinarily skilled in the art upon review of the following description of specific embodiments of the disclosure.

### BRIEF DESCRIPTION OF THE DRAWINGS

The present disclosure will be better understood having regard to the drawings in which:

FIG. 1 is a perspective view of an example thermocouple sensor according to some embodiments;

FIGS. 2A to 2C are perspective views of a sensor block of the sensor of FIG. 1;

FIG. 2D is a top view of the sensor block of FIGS. 2A to 20;

FIG. 2E is a side cross-sectional view of the sensor block taken along the line A-A in FIG. 2D;

FIG. 2F is an end view of the sensor block of FIGS. 2A to 2E;

FIG. 3A is a perspective view of the thermocouple sensor and coiled cable of FIG. 1 according to some embodiments;

FIG. 3B is an enlarged view of an end portion of a cable of the sensor in the region labeled “L” in FIG. 3A according to some embodiments;

FIG. 4A is a side view of the thermocouple sensor of FIG. 1;

FIG. 4B is a cross-sectional view of the thermocouple sensor taken along the line B-B in FIG. 4A;

FIG. 4C is a side cross-sectional view of the thermocouple sensor taken along the line C-C in FIG. 4B;

FIG. 4D is a top cross-sectional view of the thermocouple sensor taken along the line D-D in FIG. 4B;

FIGS. 5A and 5B are perspective views of the sensor of FIG. 1 mounted on a pipe;

FIG. 6 is a perspective view of an example support member;

FIG. 7A is a perspective view of the sensor of FIG. 1 mounted on the pipe in an axial alignment, and further showing a heatshield installed over the sensor according to some embodiments;

FIGS. 7B to 7D illustrate the heatshield in isolation;

FIGS. 8A to 8E are perspective views of alternate radial arrangements of a sensor on a pipe, and showing a shield installed over the sensor according to some embodiments;

FIGS. 9A and 9B are perspective views of another example sensor block according to some embodiments;

FIG. 9C is an end view of the sensor block of FIGS. 9A and 9B;

FIG. 9D is a side cross-sectional, partial view of a sensor including the sensor block of FIGS. 9A to 9C;

FIG. 9E is a perspective view of the sensor of FIGS. 9A and 9B installed with an axial alignment on a pipe.

FIG. 10 is a perspective view of yet an example sensor block for a multiple point thermocouple sensor system according to some embodiments;

FIGS. 11A and 11B are perspective view of another example sensor block according to some embodiments;

FIGS. 11C to 11E are end, top, and side views, respectively, of the sensor block of FIGS. 11A and 11B;

FIG. 12A is a perspective view of a thermocouple sensor including the sensor block of FIGS. 11A to 11E;

FIG. 12B is a perspective view of a cable of the sensor of FIG. 12A, with the sensor block removed;

FIG. 12C is a top cross-sectional, partial view of the sensor of FIG. 12A.

FIGS. 13A and 13B are perspective and end views, respectively, of another example sensor block for a thermocouple sensor according to some embodiments;

FIG. 14 is a perspective view an example circular multi-grooved bending guide tool according to some embodiments;

FIG. 15 is a perspective view of an example tool for applying “S” shaped saddle pre-bend to sensor cables;

FIG. 16A is perspective view of an example multiple point thermocouple sensor system according to some embodiments;

FIGS. 16B to 16D are upper perspective, lower perspective, and end views, respectively, of a sensor block of the sensor system of FIG. 16A, according to some embodiments;

FIG. 16E is a perspective view of the sensor system of FIG. 16A, with the sensor block removed to show wires within the sensor block;

FIG. 16F is a top cutaway view of the sensor, where a top portion of the sensor block is cutaway;

FIGS. 17A and 17B are perspective view of another example sensor block according to some embodiments;

FIGS. 17C and 17D are top and end views, respectively, of the sensor block of FIGS. 17A and 17B;

FIG. 18A is a perspective view of yet another thermocouple sensor system according to some embodiments;

FIGS. 18B and 18C are end and top views, respectively, of a sensor block of the sensor of FIG. 18A in isolation;

FIG. 19A is a perspective view of the sensor system of FIG. 18A, with the sensor block removed;

FIG. 19B is a top cross-sectional, partial view of a thermocouple sensor of the system of FIG. 18A;

FIG. 19C is another top cross-sectional, partial view of the thermocouple sensor of FIG. 19B;

FIG. 19D is a side cross-sectional, partial view of the thermocouple sensor of FIGS. 19B and 19C;

FIG. 19E is a top cross-sectional view of an additional sensor of the system of FIG. 18A;

FIG. 20 is a perspective view of another sensor block according to some embodiments; and

FIG. 21 is a flowchart of an example method according to some embodiments.

### DETAILED DESCRIPTION

In this disclosure, terminology such as “front”, “rear”, “forwards”, “rearward” or other similar terminology is used for ease of description herein, and such language does not limit the orientation or positioning of the sensor in operation.

In the drawings, stippled or dashed lines may be used to illustrate features (such as internal features) that would otherwise be hidden in the corresponding view.

Various examples of thermocouple sensors comprising a sensor block and two or more conductive wires are described herein. A sensor block may comprise one or more metals or metal composition suitable to be welded to a pipe or other object to be measured. For example, the sensor block may comprise metal including, but not limited to: stainless steel (such as 300 series, 316, 310, 304, etc.), nickel alloys (such as Inconel 600, 625, 800, 825, Hastelloy C-276, etc.), Haynes alloys (such as HR-160), and other metals. The metal composition may be selected to match the surface material being measured or to be different.

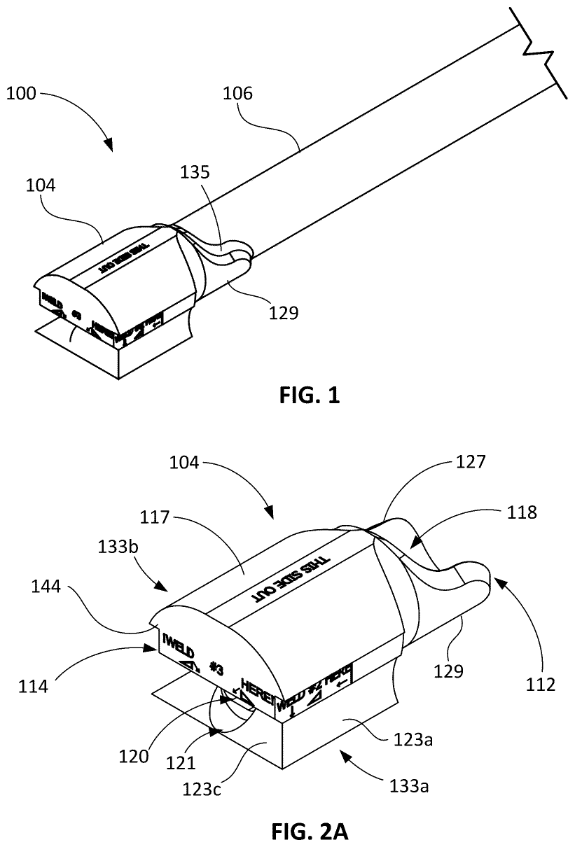

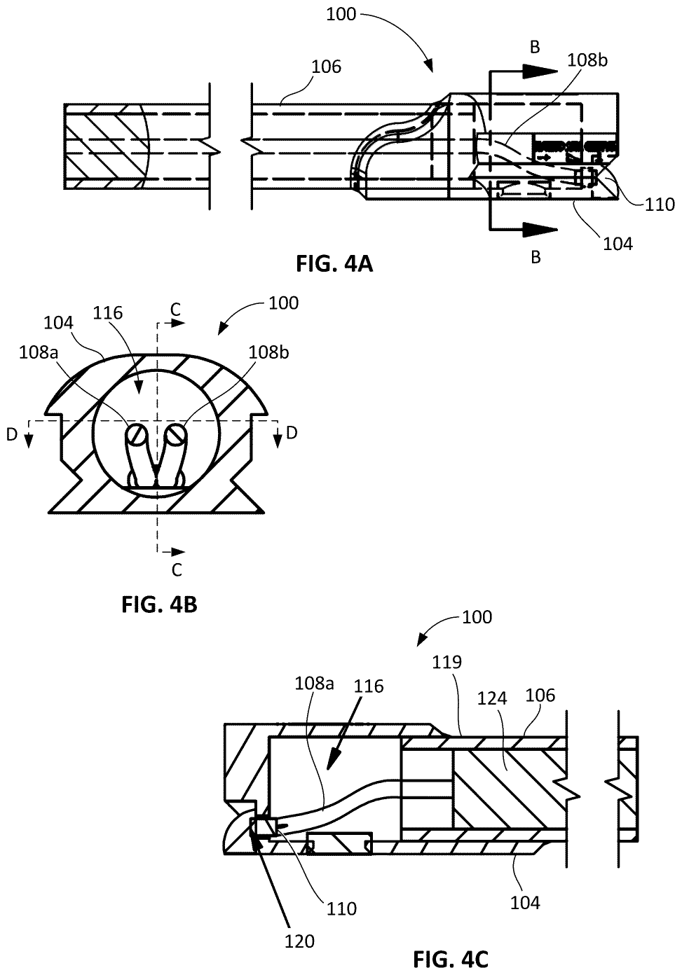

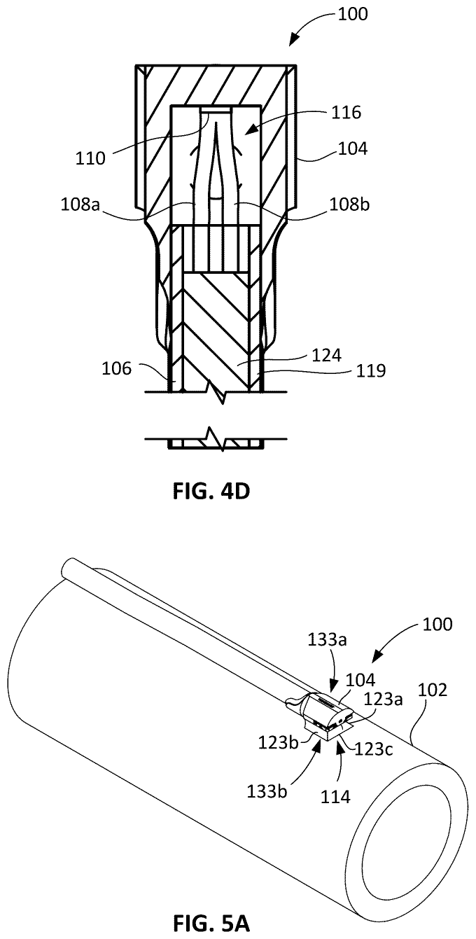

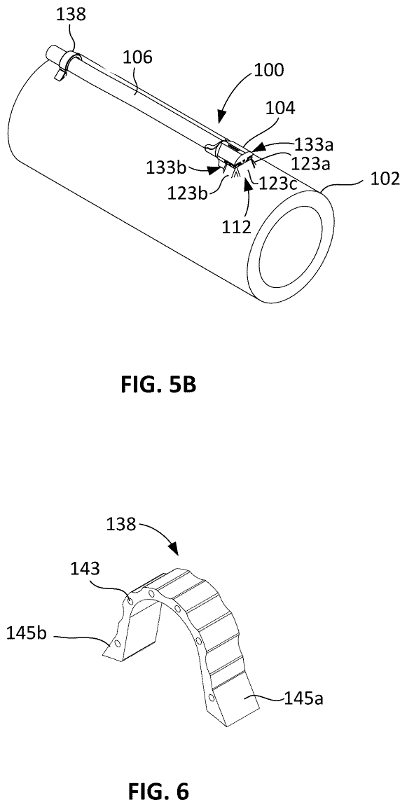

FIG. 1 is a perspective view of an example thermocouple sensor 100 according to some embodiments. The thermocouple sensor 100 may be coupled to the surface of a pipe or other object for measuring the temperature thereof. For example, the thermocouple sensor 100 may be embedded with the object by welding the thermocouple sensor 100 to the outer surface (e.g., gas tungsten arc welding (GTAW), gas metal arc welding (GMAW), resistance welding, laser beam weld, etc.). The thermocouple sensor 100 is shown coupled to an example pipe 102 in FIG. 5B. With reference to FIG. 1, the thermocouple sensor 100 generally comprises a sensor block 104, and a cable 106 containing a pair of first and second conductive wires 108a and 108b (shown in FIGS. 4B to 4D) that extend into the sensor block 104 and are joined to form a grounded junction 110 (shown in FIGS. 4A, 4C, and 4D). The junction 110 may also be considered a quasi-exposed junction in this embodiment as the wires are exposed outside of the block when seal welded. The junction 110 may be a reinforced construction where portions of the two wires 108a and 108b are continuously welded together where they touch tangentially and are aligned parallel to each other. The wires 108a and 108b may be welded together along a distance that is at least the thickness of the outer wall of the block 104. The length of the junction 110 may be at least the length of the second passage 120 such that the junction extends through the entire thickness of the sensor block from the inner chamber 116 to the outer surface of the sensor block 104. The end portions of the wires 108a and 108b may be placed adjacent and parallel to each other and welded on both sides of the abutting boundary of the wires 108a and 108b (e.g. top and bottom of the wire pair) to form the junction.

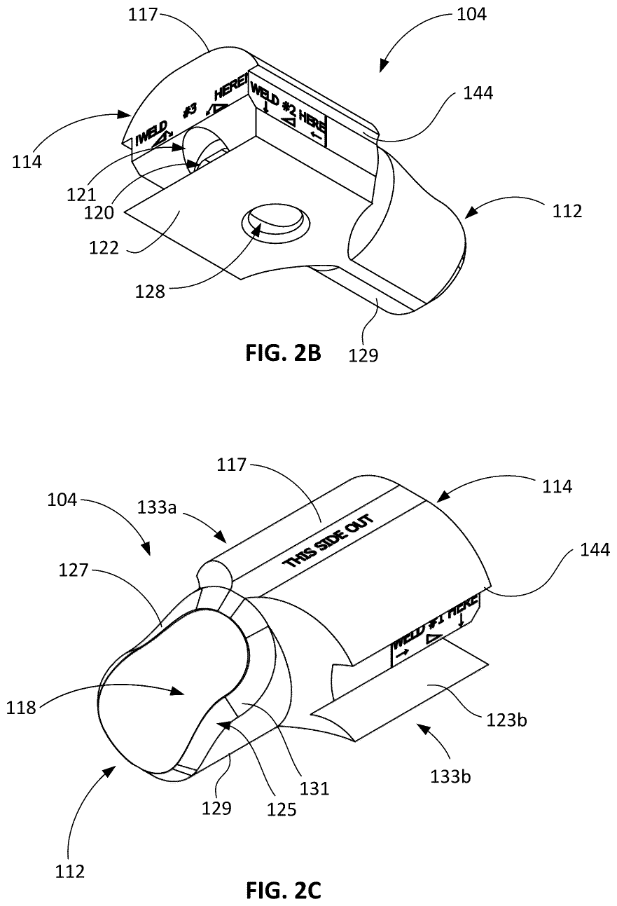

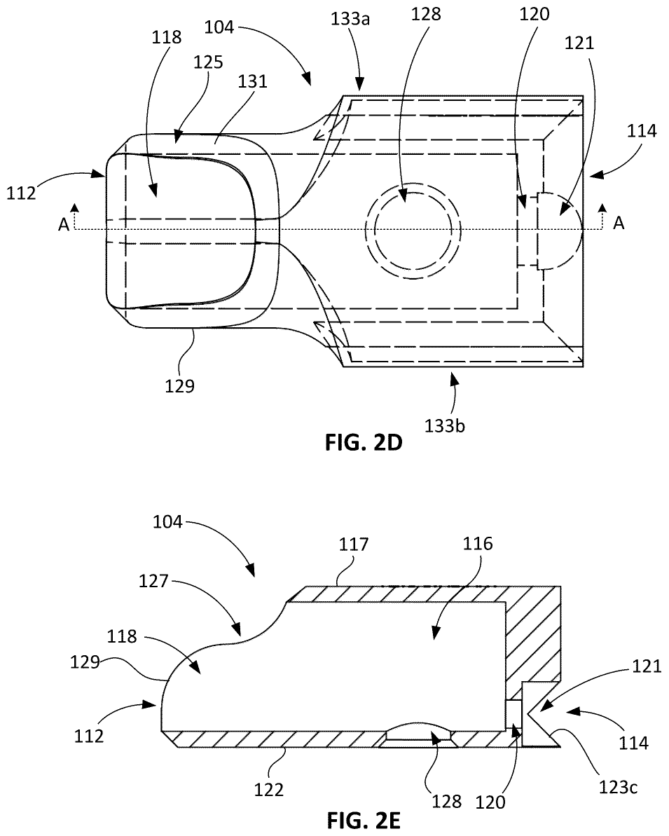

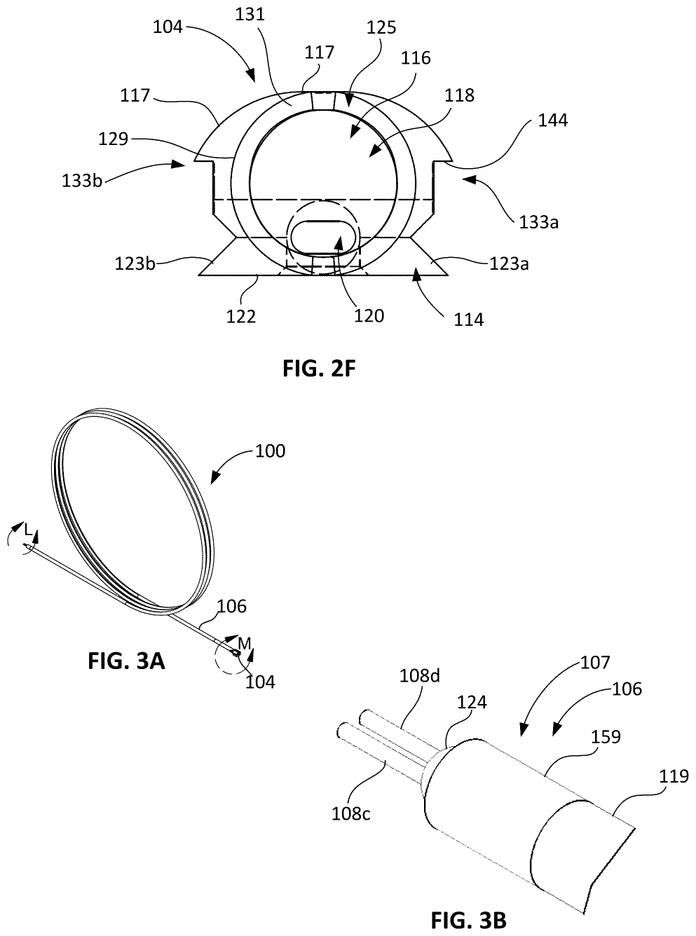

The sensor block 104 of the thermocouple sensor 100 of FIG. 1 will be described in more detail with reference to FIGS. 2A to 2F. FIGS. 2A and 2B are front-upper and front-lower perspective views, respectively, of the sensor block 104 of FIG. 1. FIG. 2C is a rear-upper view of the sensor block 104. FIG. 2D is a top view of the sensor block 104. FIG. 2E is a side cross-sectional view of the sensor block 104 taken along the line D-D in FIG. 2D. FIG. 2F is a rear view of the sensor block 104.

With reference to FIGS. 2A to 2F, the sensor block 104 has a first (rear) end 112 and a second (front) end 114 opposite the first end 112. The sensor block 104 defines an inner chamber 116, which is best shown in FIGS. 2E and 2F. The sensor block 104 further defines a first opening or passage 118 at the first end 112 for receiving the cable 106 (shown in FIG. 1). The passage 118 may have an inner diameter equal to or slightly larger than the outer diameter of the cable 106. The cable 106 may be received through the first passage 118 into the inner chamber 116. The first passage 118 is positioned near the bottom face 122 of the sensor block 104. If the cable 106 extends along a surface of the pipe or other object to be measured, the cable 106 must only raise slightly off that surface to enter the passage 118. This slight elevation change may be reduced compared to prior sensor designs. The reduction in elevation change of the cable 106 may improve longevity of the cable 106 since it is more in contact with the surface of the pipe (e.g., in furnaces and other tube-metal-temperature applications).

The sensor block 104 also defines a second passage 120, which is sized to receive the pair of first and second conductive wires 108a and 108b (see FIG. 3B). In this example, the second passage 120 extends from the inner chamber 116 to a passage opening 121 positioned at the second end 114 of the sensor block 104, near the bottom face 122. The second passage 120 is sized to hold the end portions of the wires 108a and 108b forming the junction 110. That is, the width and height of the second passage 120 is sized to accommodate the combined cross-sectional height and width of the wires 108a and 108b forming the junction 110. The end portions of the wires 108a and 108b may, or may not, protrude slightly from the first end 112 of the sensor block 104, through the second passage 120. The second passage 120 is spaced from the bottom face 122 of the sensor block 104. In this embodiment, the first and second passages 118 and 120 are each substantially parallel to the bottom face 122 and extend axially relative to the first and second ends 112 and 114.

The sensor block 104 optionally includes a first weld preparation region (123a to 123c) extending at least partially around the periphery of the sensor block adjacent the bottom face 122. The second passage 120 in which the junction 110 is formed is positioned at or near the weld preparation region (123a to 123c). The weld preparation region in this example comprises side bevelling 123a and 123b along sides 133a and 133b and end bevelling 123c along the second end 114 of the sensor block 104. The bevelling 123a to 123c may be referred to as “wings” and may be configured for flat recess for autogenous seal welding of the wires 108a and 108b to the sensor block 104. When the sensor block 104 is welded to a surface, the beveled (i.e. tapered) wings of the weld preparation region (123a to 123c) may improve integrity of the weld due to thin edges. Marking guides may be provided on or near the weld preparation region (123a to 123c) to indicate where to weld and how much to weld. The second passage 120 is positioned at least partially within the end bevelling 123c.

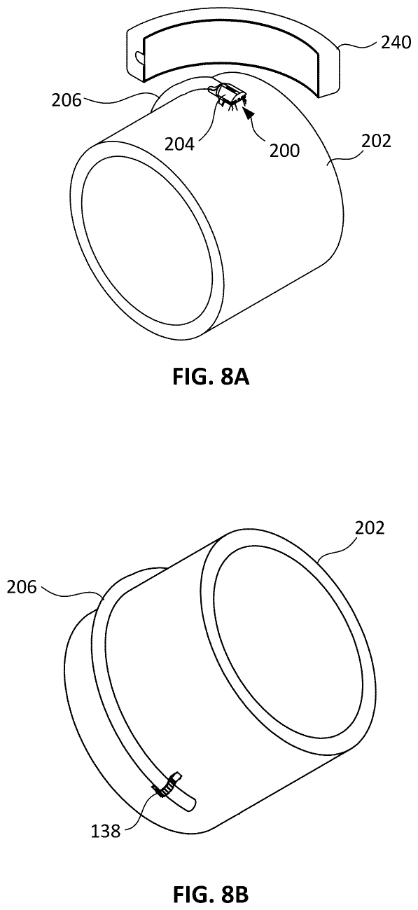

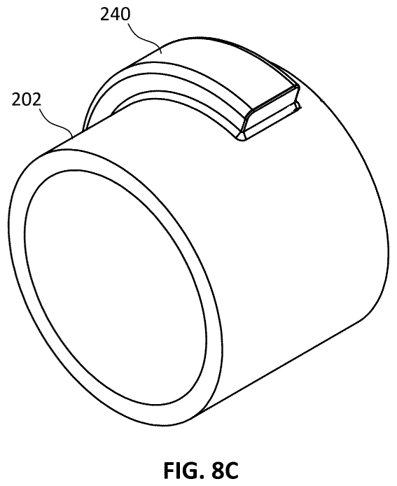

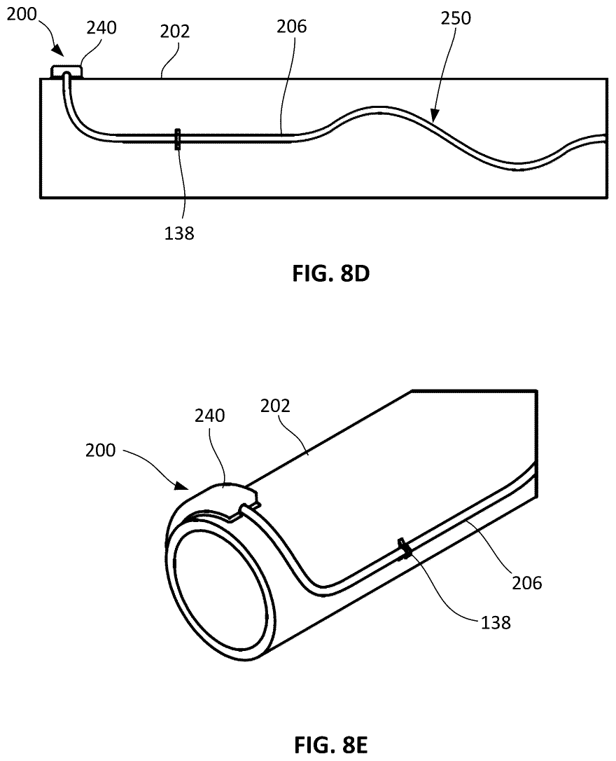

In this embodiment, the first passage 118 of the sensor block 104 (for receiving the cable 106 therethrough) is formed by a tubular section 129 at the first end 112 of the sensor block 104. The tubular section 129 may be welded to the cable's sheath 119 (as shown by welded rim 135 in FIG. 1). The weld may seal the tubular section 129 to the cable 106. The tubular section 129 may help accommodate a coil of the cable 106 attached to the sensor block 104. The tubular section 129 in this example defines a directional strain relief 127 (best shown in FIG. 5), which is in the form of an upper recess in the tubular section 129 at the first end 112. The strain relief 127 may provide clearance for radial expansion or deformation of the cable 106 if the cable 106 is bent near the sensor block 104 (for example to wrap the cable 106 around a pipe on which the sensor block 104 is mounted). The directional strain relief 127 may, thus, help prevent the weld to the tubular section 129 from cracking when the cable 106 is wrapped tightly around the pipe (such as the pipe 102 in FIGS. 8A and 8B).

The sensor block 104 optionally further comprises a second weld preparation region 125 extending at least partially about the rim of the tubular section 129. The second weld preparation region 125 in this embodiment comprises a chamfered rim 131 of the tubular section 129. The second weld preparation 125 may be configured for a weaving or zig zag welding pattern to provide strength to the joint.

The upper surface 117 of the sensor block may optionally be curved in the plane transverse to the length of the sensor block 104. The curvature of the upper surface may be configured to fit in standard calibration blocks to allow calibration (verification) of the sensor measurement tolerance.

The bottom surface 122 of the sensor block 104 may be shaped to match the curvature of the tube/pipe it is being installed onto in any orientation by machining it to fit the curvature when specified. The sensor block 104 may have markings (e.g. indicating where to weld) to notify installers and prevent damage to the brazed (or welded) transition when handling. The in-line transition section 159 may also have markings (e.g. text) to provide instructions to a user. In-line transitions may have the option of a higher strength laser weld, or orbital GTAW weld.

FIG. 3A is a perspective view of the thermocouple sensor 100 showing a greater length of the cable 106 attached to the sensor block 104. FIG. 3B is an enlarged view of an end portion 107 of the cable 106 in the region labeled “L” in FIG. 3A. The portion of the sensor within the region labelled “M” in FIG. 3A is generally shown in FIG. 1.

The cable 106 in this embodiment may be a Mineral Insulated Cable (MIC), although embodiments are not limited to a particular type of cable. In this example, the first and second conductive wires 108a and 108b (see FIGS. 4A to 4D) extend parallel to each other within a metal cable sheath 119. With reference to FIG. 3B, the wires 108a and 108b may be transitioned (e.g. spliced) to lead wires 108c and 108d within an inline transition section 159. An insulating mineral material (not shown) fills the space around the first and second conductive wires 108a and 108b within the cable sheath 119, thereby electrically insulating the wires 108a and 108b from each other. FIG. 3B shows an epoxy 124 sealing the end of the cable 106, which covers the insulating material within the cable 106 in this view. Rather than epoxy, another insulating potting material, such as ceramic cement, may be used. Embodiments are not limited to the cable 106 of FIG. 1. For example, the specific conductive material(s) and/or insulating material(s) of the cable 106 may vary. Additionally, other suitable means of guiding first and second conductive wires into a sensor block may be used. For example, the first and second conductive wires 108a and 108b may not be integrated into a single cable in other embodiments (e.g. two separate wires, each with their own sheath may be inserted into the block 104).

FIG. 4A is a side view of the thermocouple sensor 100, where stippled lines are used to indicate features of the cable 106 and internal details of the sensor block 104 that would otherwise be hidden in that view. FIG. 4B is a cross-sectional view of the thermocouple sensor 100 taken along the line B-B in FIG. 4A. FIG. 4C is a side cross-sectional view of the thermocouple sensor 100 taken along the line C-C in FIG. 4B. FIG. 4D is a top cross-sectional view of the thermocouple sensor 100 taken along the line D-D in FIG. 4B.

With reference to FIGS. 4A to 4D, the wires 108a and 108b extend from the insulation of the cable. The wires 108a and 108b extend through the inner chamber 116 and into the second passage 120. The wires in this example are welded together at distal ends thereof to form the junction 110. The length of the end portions of the wires 108a and 108b that are welded together to form the junction may vary. The wires 108a and 108b may be welded together (or otherwise coupled) prior to being inserted into the second passage 120 of the sensor block 104. Alternatively, the wire end portions may be inserted into the passage 120 without being joined together, and then the wires may be coupled to form the junction 110 by means of welding the block 104 to the pipe or other object to be sensed. The junction 110 is a reinforced junction in that the wires 108a and 108b are welded together to form one larger wire longer section of wire that may stand up to welding without detaching and breaking the circuit.

The junction 110 may be positioned at least partially within the second passage 120. The junction 110 may extend at least partially from the passage 120. The junction 110 may be exposed and bent down to the bottom of the block 104 for direct surface contact. Distal end portions of the wires 108a and 108b may be inserted into the second passage 120. The end portions of the wires 108a and 108b may be welded together to form the junction 110. The end portions of the wires 108a and 108b may also be welded to seal the second passage 120. This design may allow for smaller diameter wires to be used in creating the junction. The junction may extend partially or fully outward from the second passage 120 in some embodiments, with the junction 110 and sensor block 104 being welded to the surface of the object to be measured. Exposing more of the combined wires 108a and 108b may increase the accuracy and response time of the sensor 100. The combined junction 110 may also be more heat stable than the junction disclosed in U.S. Pat. No. 7,789,555, the entire contents of which are incorporated herein by reference since there may be no transition from smaller wires to larger wires (8 AWG). Additionally, the length of the junction 110 may beneficially be increased or decreased by increasing or decreasing the length of the portions of parallel wires 108a and 108b that are joined together.

The pair of wires 108a and 108b that are joined at their ends to form a thermocouple junction 110 may be joined together (e.g. welded) prior to being inserted into in the second passage 120. In other embodiments, the wires may be joined by the process of welding the sensor block 104 to the pipe 102.

The inner chamber 116 of the sensor block 104 may be filled with an insulating material, such as a mineral powder. The mineral powder may, for example, comprise MgO, AIO and/or other mineral compositions. The insulating material may comprise epoxy, fiber, or cement, for example. In this embodiment, the sensor block defines a hole 128 (see FIGS. 2D and 2E) in the bottom face 122 that provides an inlet to the chamber 116 for the insulating mineral powder, or another type of insulation. For example, mineral powder may be placed into the chamber 116 via the hole 128 after the cable 106 (including wires 108a and 108b and junction 110) have been coupled to the sensor block 104. Various methods, such as vibration, may be used to help the powder fill any air pockets the chamber. A tool (e.g. simple wire or small rod, a press with a dye, etc.) may be inserted through the hole 128 to compress the powder. After filling the chamber 116 with the mineral powder, the hole 128 may be closed and sealed.

With the cable 106 and wires 108a/108b engaged with the sensor block 104 and sealed, the inner chamber 116 containing mineral powder may be effectively sealed from the outside environment, which may improve the lifetime of the thermocouple sensor 100. When assembled, the sensor block 104 of the thermocouple sensor 100 may be capable of withstanding pressures up to 1,000 psig or more.

An example process for installing the thermocouple sensor 100 described above to a pipe will now be described with reference to FIGS. 5A to 5B.

As shown in FIG. 5A, the thermocouple sensor 100 may be positioned on a pipe 102 with the bottom face 122 of the sensor block 104 on the pipe 102. The bevelling 123a to 123c (collectively, the first weld preparation) of the sensor block 104 is adjacent the pipe 102. The sensor block 104 and cable 106 may be aligned with the longitudinal axis of the pipe 102.

With reference to FIG. 5B, the sensor block 104 may be welded to the pipe 102. In this example welds are made in the region of the bevelling 123a to 123c (first weld preparation) along the sides 133a and 113b and then second end 114 of the sensor block. By way of example, the side bevelling 123a and 123b of the weld preparation may be tack welded indicated along the sides 133a and 133b of the sensor block 104. The length of the front bevelling 123c at the second end 114 of the sensor block 104, which includes the junction 110 shown in FIGS. 4A and 4C, may then be welded, although the order of welding may vary. The metals of the sensor block 104, junction 110 and pipe 102 may thus be joined or incorporated together by the welding process.

Optionally, the installation process may further include securing a non-binding support-guide or support-bracket over the cable 106 at a position spaced from the sensor block 104. For example, a U-shaped support 138 shown in FIGS. 5B and 6. FIG. 6 shows the support 138 in isolation. The support 138 may be secured (e.g. tack welded) to the pipe 102 on both sides of the cable 106. FIG. 5B shows the support 138 mounted to the pipe 102 over the cable 106. The support 138 may attach to the pipe 102 and not grip the cable 106, so that the cable 106 can slide relative to the support 138. Any suitable method for securing or supporting the cable 106 may be used, such as slotted versions for pipe clamps, and/or banding. For example, wings 145a and 145b at ends of the support 138 may be welded to the pipe 102. Embodiments are not limited to the support 138 shown. A refractory cover (e.g., ceramic cement) may be added to the surface of the support 138. The support 138 in this example include holes 143 that may assist in retaining the refractory cover material. Wires (not shown) may also extend through the holes 143 to help retain the cover material. The supports 138 may also be welded (or have slots to accept) to a pipe clamp (or banding) rather than directly to the pipe 102.

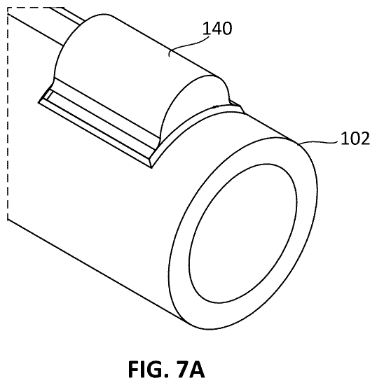

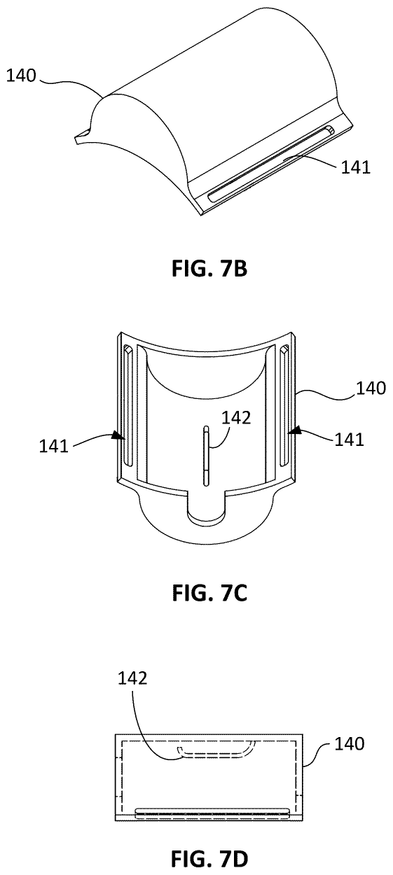

In some embodiments, an insulating material may be placed over the thermocouple sensor 100 after the sensor 100 has been embedded in the pipe (or other object). The insulation may be covered and/or secured in position by a shroud (which may be a heatshield). FIG. 7A shows an optional shield 140 or shroud that covers the sensor 100 (FIGS. 5A and 5B) installed on the pipe 102 that may be secured over the thermocouple sensor 100 and retain an insulating material therein. The shield 140 containing the insulating material may be referred to as a “heatshield”.

The heatshield 140 may provide shielding from convection, radiation, and flame impingement. The heatshield 140 may include external ceramic cement coating for protection from absorbing too much heat. The ceramic coating may reduce fin heat transfer effects that could cause the thermocouple sensor 100 to read a higher temperature for the surface it is on. Higher strength metal sheaths can also be provided to be potted in place with ceramic cement. These may come with internal insulation clips that hold the refractory in place. Optional pre-formed rigid insulation may be used. Optional higher density fiber mat may be used. When supplied with the heatshield, the sensor block may have surface features (slots and barbs/spikes) for improved performance and to hold the refractory onto the block better. These retention surfaces may allow loose refractory materials without metal sheaths to be installed over the block (such as refractory putties, or ceramic cement that need to cure in place before they are solid).

FIGS. 7B to 7C are top perspective, bottom perspective, and side views, respectively, of the example heatshield 140 that may be hold an insulating material over the thermocouple sensor 100. The heatshield 140 may function as a heat shield. The heatshield 140 may be filed with insulation, placed over the thermocouple sensor 100, and welded to the pipe 102, or clamped or banded in place with slots 141 along sides of the shield (or any other suitable fastening means). The heatshield 140 may include one or more retaining hooks 142 or other means for holding the insulating material within the heatshield 140.

The heatshield 140 may be omitted in other embodiments. Optionally, an insulation material such as ceramic cement (or refractory putty) may be applied directly to the thermocouple sensor 100 without a heat shield placed over the insulation material. As shown in FIGS. 2B to 2C, the sensor block 104 in this example includes optional overhang shoulders 144 (or “wing tips”) along sides 133a and 133b, shown in FIGS. which may aid in retaining ceramic cement or another insulation material on the thermocouple sensor 100. Insulation material may be pressed around and grip the shoulders 144. Alternatively, the heat shield may include hooks to latch to the shoulders 144 of block. Other methods of securing insulation and/or the heat shield may be used in other embodiments. The hooks 142 can also be used to hold insulation in place inside of the heatshield (shroud) 140.

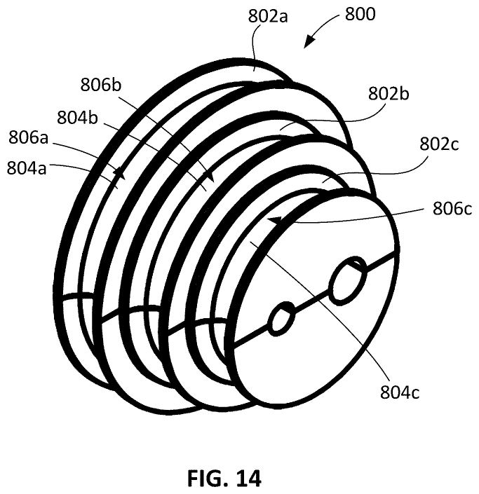

FIGS. 8A to 8C illustrate an alternative installation or arrangement of a thermocouple sensor 200, including a sensor block 204, on a pipe 202 according to some embodiments. In this example, the sensor 200 and cable 206 are oriented to extend circumferentially about the pipe 202. In other words, the sensor 200 is mounted with the cable extending transverse to the axis of the pipe 202. The cable 206 wraps circumferentially around the pipe 202. The sensor 200 is similar to the sensor 100 described above with reference to FIGS. 1 to 7D, but may have a bottom face curvature configured to match the curvature of the pipe surface in this orientation. Another embodiment of a heatshield 240 is also illustrated. FIG. 8A shows the heatshield 240 prior to installation, and FIG. 8C shows the heatshield installed over the sensor 200. The heatshield 240 is shaped with an inner curvature that follows the curvature of the pipe 202. The cable 206 may be bent or pre-bent in a spiral shape around the pipe 202. A circumferential (radial) bend or spiral bend may be applied using the tool 800 in FIG. 14, for example.

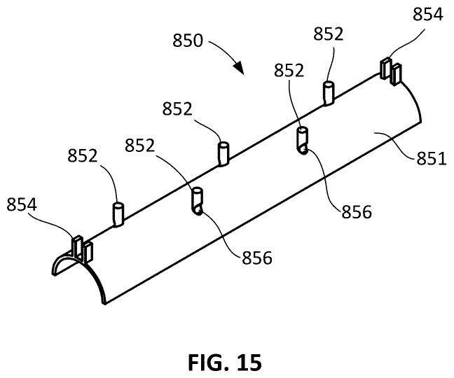

FIGS. 8D and 8E illustrate another arrangement of the thermocouple sensor 200, including the heatshield 240, on the pipe 202 similar to FIGS. 8A to 8C. In this embodiment, the cable 206 includes an S-shaped pre-bend. The S-shaped bend may be applied using the tool 850 in FIG. 15, for example. A spiral bend and/or S-shaped pre-bend of the cable 206 may provide thermal expansion relief, while allowing the cable 206 to stay in contact with the pipe 202.

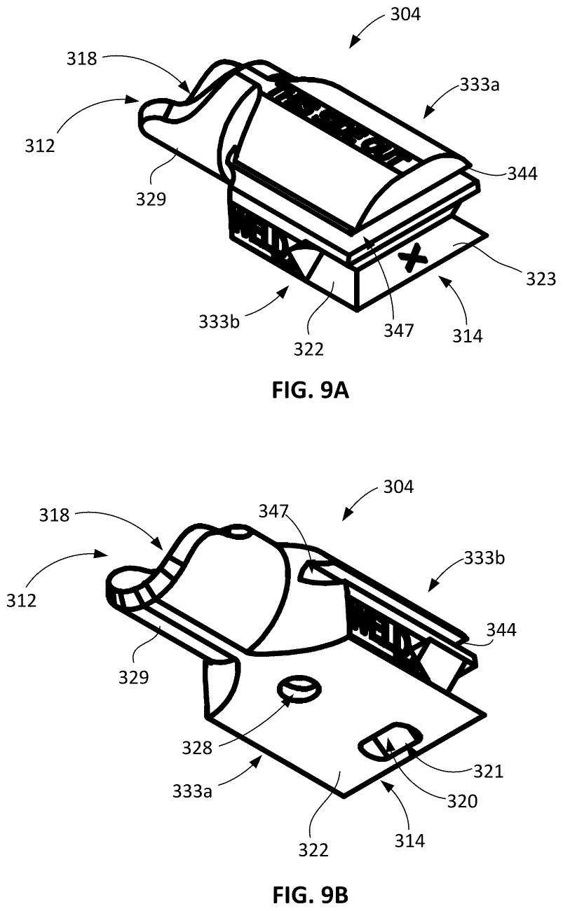

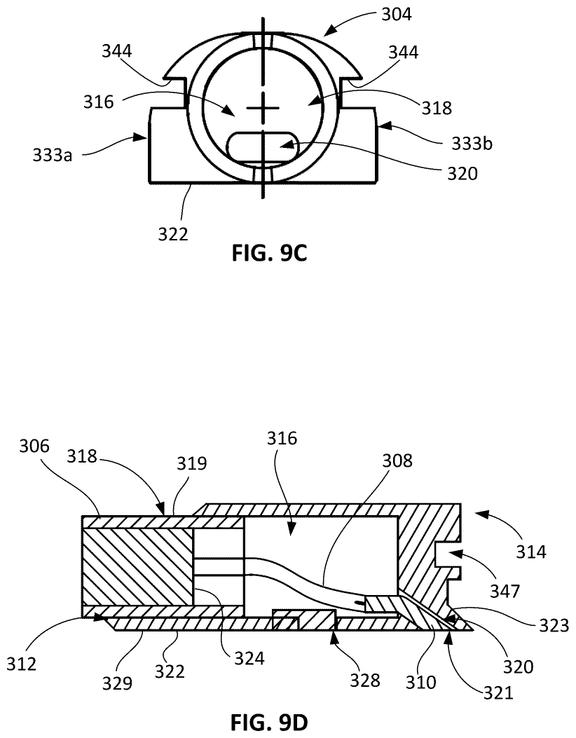

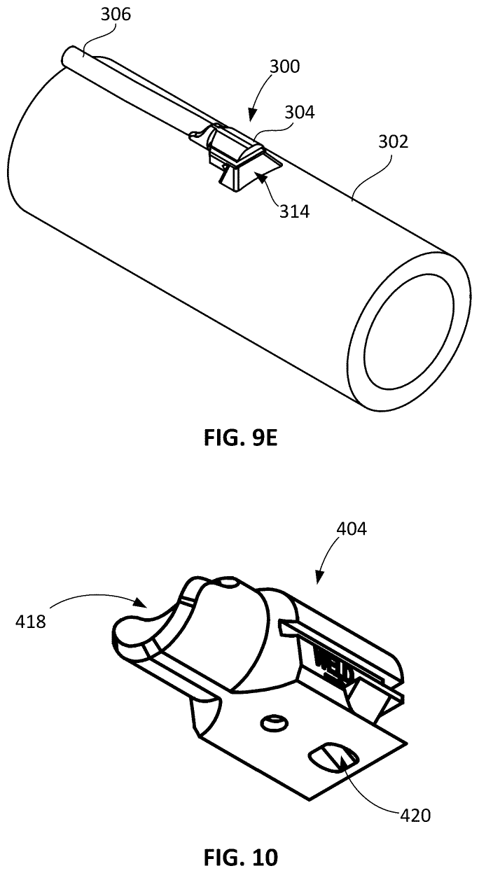

FIGS. 9A to 9C illustrate another example sensor block 304, according to some embodiments. The sensor block 304 is similar to the sensor block 104 of FIGS. 2A to 2E, with some differences as described below. A cable with a pair of conductor wires (such as the cable 106 in FIGS. 3A and 3B) may be combined with the sensor block 304 to form a thermocouple sensor, with the pair of conductive wires forming a thermocouple junction. The junction may be positioned at the bottom of the block in direct contact with the measurement surface.

The sensor block 304 has a first (rear) end 312, a second (front) end 314, and sides 333a and 333b. Similar to the sensor block 104 of FIGS. 2A to 2E, the sensor block 304 defines an inner chamber 316 (FIG. 9D) and comprises a first passage 318 extending from the first end 312 of the sensor block into the inner chamber 316. The sensor block 304 also defines a second passage 320 extending from the inner chamber 316 to an outer surface of the sensor block 304. The sensor block 304 also includes downward facing shoulders or wing tip shoulders 344 similar to the sensor block 104 of FIGS. 2A to 2E that may assist with holding or retaining an insulating material (e.g. refractory insulation, cement, or putty) on top of the sensor block 304. The shoulders 344 are defined by a recessed notch or groove 347 that extends about the sides 333a and 333b and second end 314 of the sensor block 304 in this example.

In this embodiment, however, the second passage 320 extends to the bottom face 322 of the sensor block 304. The opening 321 of the second passage 320 (at the bottom face 322) may be proximate the second end 314 of the sensor block 304. The second passage 320 extends, from the inner chamber 316 and to the opening 321 at a downward angle and toward the second end 314. The downward angle may be between 20 and 45 degrees relative to the bottom face 322, for example. The angle may be approximately 30 degrees (e.g. 27 degrees) relative to the bottom face 322, for example. The junction 310 at bottom face 322 of the block may beneficially be in contact with the surface to be measured (e.g. pipe surface) before welding is started. The angle of the passage 320 may facilitate ease of insertion of the conductive wires forming the junction 310. The opening 321 in this example is positioned at least partially under the weld preparation region 323 (i.e. at least partially under the bevelled surface of the weld preparation region 323), such that welding the weld preparation region also welds the junction 310 within the passage 320. These weld preparation regions may also help to conform to a non-uniform or round surface of the pipe to increase the contact of the block with the pipe for better accuracy. The increased contact with the surface of the pipe may decrease contact resistance and provide for better heat transfer.

FIG. 9D is a side cross-sectional view of a sensor 300 comprising the sensor block 304 attached to a cable 306. The cable 306 is similar to the cable 106 shown in FIGS. 3A and 3B. More particularly, the cable 306 includes a pair of conductive wires, including a first wire 308 and a second wire (not visible) within a metal cable sheath 319. FIG. 9D shows a mineral insulation 324 electrically isolating the end of the cable sheath 319 from the wires 308. The conductive wires 308 form a junction 310 at their ends, at least partially within the second passage 320. The junction 310 may extend at least partially from the second passage 320. The cable sheath 319 may be welded to the tubular section 329 of the sensor block 304 (at the first end 312). The length of the junction 310 may be at least the length of the second passage 320 such that the junction extends through the entire thickness of the sensor block from the inner chamber 316 to the outer surface of the sensor block 104. The end portions of the wires 308a and 308b may be placed adjacent and parallel to each other and welded on both sides of the abutting boundary of the wires 308a and 308b (e.g. top and bottom of the wire pair) to form the junction.

Similar to the example sensor block 104 in FIGS. 2A to 2F, the sensor block 304 defines a hole 328 in the bottom face 322 that may be used to fill the inner chamber 316 with an insulating material after the cable 306 and wires 308 are installed, and the hole 328 may then be plugged.

The sensor block 304 includes a beveled weld preparation region 323 along the second end 314 of the sensor block, adjacent to the bottom face 322. The second passage 320 extends partially under the beveled weld preparation region 323. In this example, the weld preparation region is marked with an “X” (FIG. 9A) to assist a person welding the sensor block to an object, such as a pipe, to know where to weld the measurement location (or point). The weld preparation region 323 may also function as a guide to show where to weld around the front end 314 and sides 333a and 333b adjacent the bottom face 322. The beveled, groove shape of the weld preparation region 323 being distinct from the groove 347 above the weld preparation region 323 may also provide a visual indication to not to weld the upper groove 347 that is used to hold insulation on after welding.

The position of the junction 310 and second passage 320 (extending to the bottom face 322 may facilitate better welding of the sensor block and junction 310 to the pipe 102. Thus, position of the junction 310 and second passage 320 may improve sensing accuracy. The position of the junction 310 may also reduce the likelihood of damaging the shoulders 344 and groove 347 in the welding process.

FIG. 9E is a perspective view of the sensor 300 mounted to a pipe 302. The sensor block is welded along the weld preparation region 323 at the second end 314 and partially along sides 333a and 333b of the sensor block 304. This welding may fuse the metals of the junction 310 (FIG. 9D), the sensor block 304 and the pipe 302.

The pair of wires 308a and 308b that are joined at their ends to form a thermocouple junction 110 may be joined together (e.g. welded) prior to being inserted into in the second passage 320. In other embodiments, the wires may be joined by the process of welding the sensor block 304 to the pipe 302.

FIG. 10 is a perspective view of yet another embodiment of a sensor block 404, which is similar to the sensor block 304 of FIGS. 9A to 9C. However, the sensor block 404 has a larger-diameter first passage 418 and a wider second passage 420. The larger-diameter first passage 418 may accommodate a cable with a larger diameter. The larger second passage may accommodate larger wires or a larger number of wires forming a single junction or multiple wires (e.g. four or more wires) into a common junction.

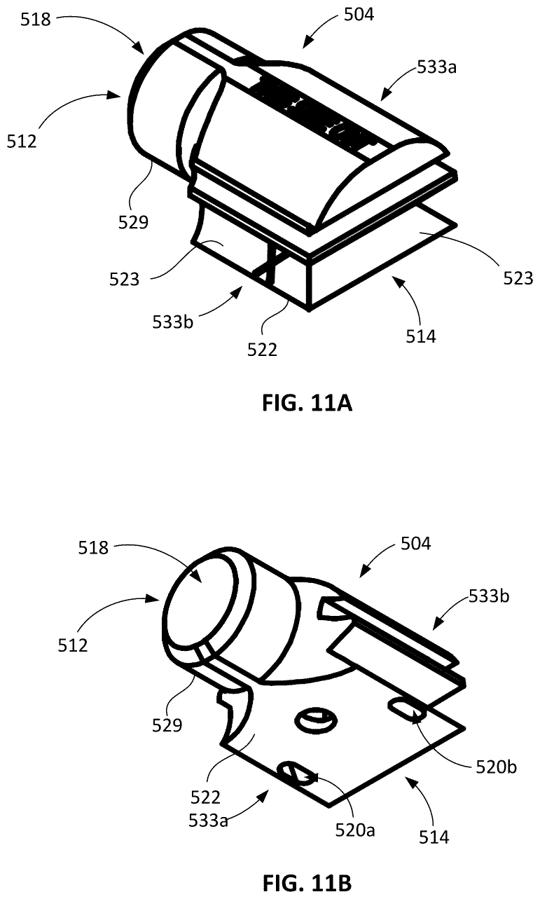

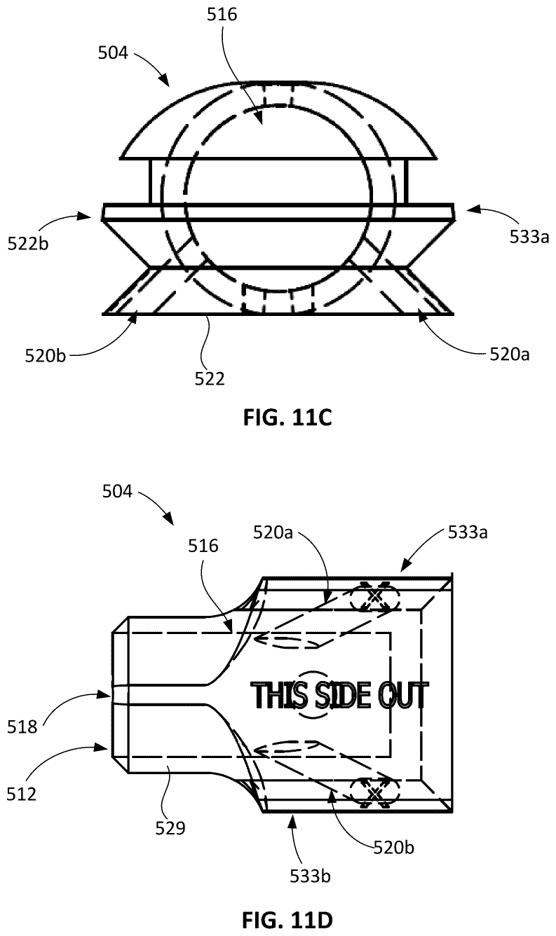

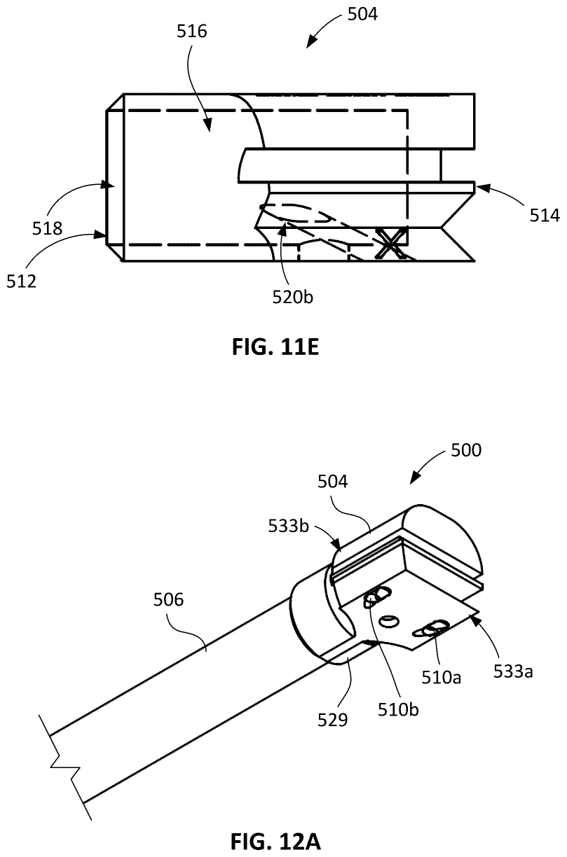

In some embodiments, a thermocouple sensor includes multiple sets (e.g. pairs) of conductive wires forming multiple junctions in a sensor block welded to a pipe or other object. FIGS. 11A to 11E illustrate another sensor block 504 according to some embodiments. FIGS. 11A and 11B are upper and lower perspective views, respectively of the sensor block 504. FIGS. 11C, 11D and 11E are end, top, and side views, respectively, of the sensor block 504, with stippled or dashed lines indicating internal features that would be hidden in those views.

The sensor block 504 in FIGS. 11A to 11E is similar to the other sensor blocks 104, 204 and 304 discussed above, with some differences discussed below. Similar to other examples discussed above, the sensor block 504 has a first (rear) end 512, a second (front) end 514, and sides 533a and 533b. Also similar to other examples described above, the sensor block 504 defines an inner chamber 516 (FIGS. 11C to 11E) and comprises a first passage 518 extending from the first end 512 of the sensor block into the inner chamber 516.

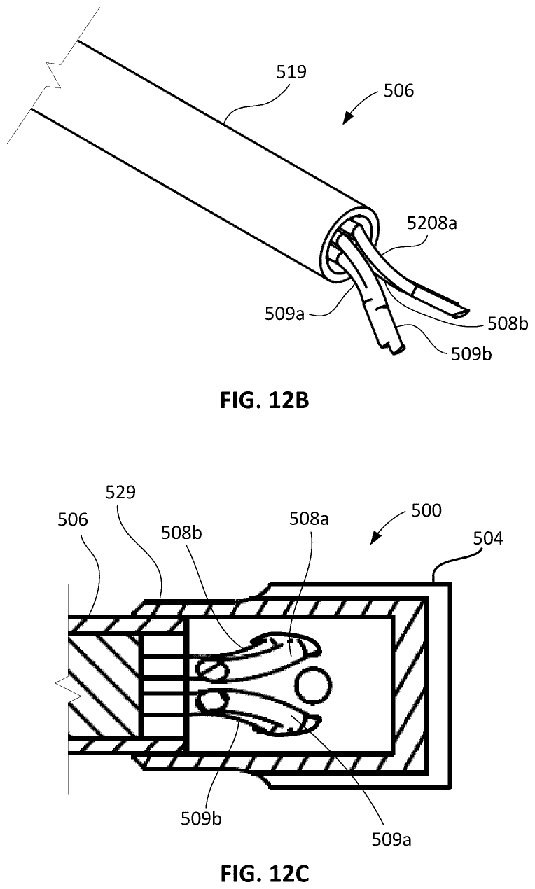

The sensor block 504 in this example, however, includes two (second) wire passages 520a and 520b, each for receiving a respective pair of conductive wires to form a respective separate junction therein (see FIGS. 12A and 12C described below, for example). The passages 520a and 520b are each configured similarly to the second passage 320 of the sensor block 304 in FIGS. 9A to 9C (extending at an angle to the bottom face 522 of the sensor block 504), but the two passages 520a and 520b are spaced laterally apart. Starting from the surface of the first passage 518, the two passages 520a and 520b in this example extend downward, towards the second end 514, and towards opposite sides (533a, 533b) of the sensor block 504. The inclusion of two junctions 510a and 510 beneficially provides two sensor measurement points for redundancy. The angle of the passages 520 may facilitate insertion of the conductive wires forming the junctions 510a and 510b. The length of the junctions 510a and 510b may be at least the length of the second passages 520a and 520b.

A cable comprising two pairs of conductive wires may be received into the first passage 518, with each pair of wires extending into a respective one of the passages 520a and 520b to form a respective junction therein. The two junctions 520a and 520b may be spaced apart (at the bottom face 522) by an eight of an inch or more, for example, in some embodiments. The two junctions 520a and 520b may be spaced apart by a quarter of an inch in some embodiments. Spacing of the junctions in these ranges may be beneficial in preventing both junctions 520a and 520b failing at the same time. The junctions 520a and 520b may be positioned at or near opposite sides 533a/533b of the block 504 while still fitting inside of a standard calibration block.

The weld preparation region 523 in this embodiment comprises a bevelled section or “wing” (similar to other embodiments) that extends around the sides (533a, 533b) and second end 514. The weld preparation region 523 may be sized to avoid melting the sheath and damaging the sensor when the sensor block 504 is welded to a surface. For example, the weld preparation region 523 may be close to the thickness of the cable 506, and the weld preparation region 523 may help the sensor block 504 conform to the pipe surface when the sensor block 504 is welded to the pipe, as noted above. The collar 529 may similarly have thickness (e.g. matching the cable thickness) to helps with preventing the welding from pulling the mineral insulation out of the cable 506 during the welding process which can damage the sensor.

FIG. 12A is a perspective view of a thermocouple sensor 500 comprising the sensor block 504 of FIGS. 11A to 11E connected to a cable 506. FIG. 12B is a perspective partial view of the cable 506 and the pairs of wires (508a/508b, 509a/509b) extending from the sheath 519. FIG. 12C is a top cross-sectional, partial view of the sensor 100 of FIG. 11F. The cable 506 comprises two pairs of conductive wires 508a, 508b, 509a and 509b and an outer cable sheath 519. The sheath 519 may be welded to the tubular section 529 at the first end 512 of the sensor block 504.

Each pair of wires (508a/508b, 509a/509b) extends into a respective one of the passages 520a or 520b and forms a thermocouple junction 510a and 510b therein. Thus, two separate thermocouple junctions 510a and 510b are provided near opposite sides 533a and 533b of the sensor block 504.

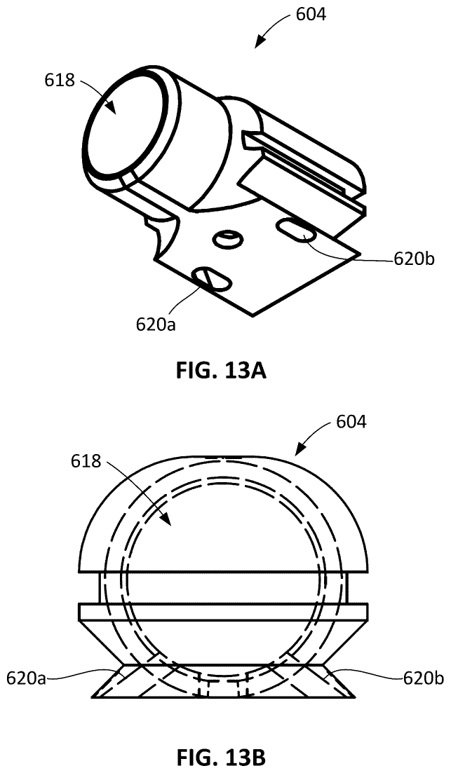

FIGS. 13A and 13B are perspective and end views, respectively, of another example sensor block 604 for a thermocouple sensor according to some embodiments. The sensor block 604 is similar to the example of FIGS. 11A to 11E, but with a first passage 618 sized to receive a larger grade of cable. The second passages 620a and 620b are similarly sized to receive larger diameter conductive wire pairs, relative to the example of FIGS. 11A to 11E.

The design of the thermocouple sensors described herein may have various advantages or benefits. In some embodiments, the thermocouple sensor may be assembled and/or installed without needing to wait for drying or curing ceramic cement. If ceramic cement is used as insulation in the heat shield, it may be pre-installed in the shield. The design of the thermocouple sensor may improve accuracy of the thermocouple sensor (testing has shown improvements). For example, with reference to U.S. Pat. No. 7,789,555, the junction of the present design may be comparatively reduced in size relative to the sensor block and the insulation of the conductive wires (forming the junction) with mineral powder up to the point where the sensor is to be embedded, which may increase the accuracy of measurements when compared to a bare surface without the sensor. The reduced size of the axially reinforced junction may allow for the use of smaller wires while maintaining heat stability when being welded. The wires, when welded together to form the junction may essentially form a larger single conductive wire over the length of the junction, which may provide welding stability.

A sensor cable (such as cable 106 or 306 discussed above) may be bent/wrapped around a pipe or other tubular structure for a tight spring-loaded fit. In some embodiments, an installation tool may be used to apply a pre-spring/pre-flex to improve longevity of the cable and reduce measurement errors due to overheating in the gas environment. FIG. 14 is a perspective view an example circular multi-grooved bending guide tool 800 that may be used to provide pre-spring bends for different tube/pipe sizes. The tool 800 comprises a plurality of circular discs 802a to 802c, each having a different diameter and a respective outer rim 804a to 804c defining a respective annular groove 806a to 806c. The diameters of the discs 802a to 802c are selected to be equal to or less than the diameters of pipes to which a sensor may be mounted. The cable may be wrapped around the disc (802a, 802b, or 802c) corresponding pipe to apply a pre-bend prior to installation of the sensor.

FIG. 15 shows an example tool 850 for applying “S” shaped saddle pre-bend for different pipe sizes. The tool comprises a saddle 851 and upstanding guide pins 852 positioned between end forks 854. A cable may be wrapped around pins 852 to apply the “S” shaped pre-bend. The forks 854 may be used to secure or stabilize the cable while the pre-bend is applied. Side facing grooves 856 may be provided on the guide pins 852 to help secure the cable when applying the bend. Dual grooves may be provided on the pins 852 allow for adjustment in bend sizing. The saddle 851 may have curvature with a smaller in diameter than the pipe (or other tubular) to which the sensor will be mounted, in order to provide pre-spring/pre-flex to the cable so it holds tight to the outer surface of the pipe (or other tubular).

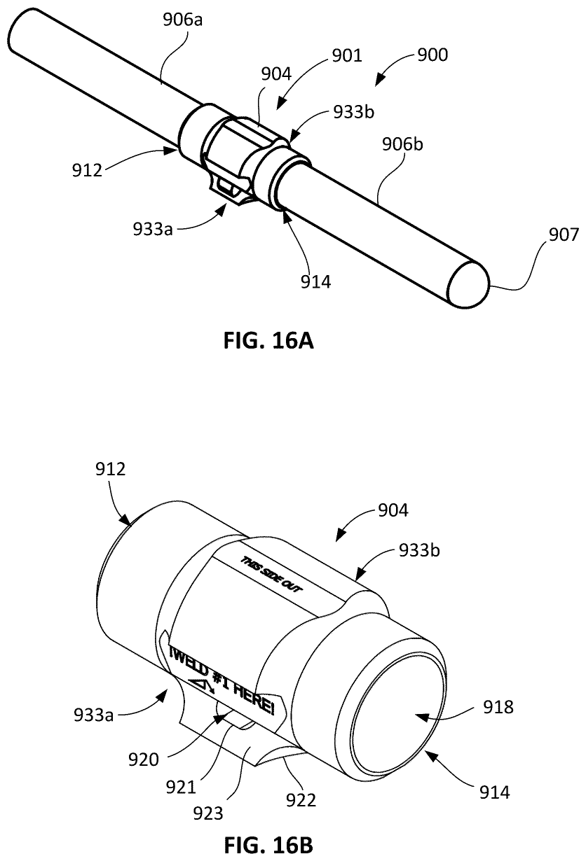

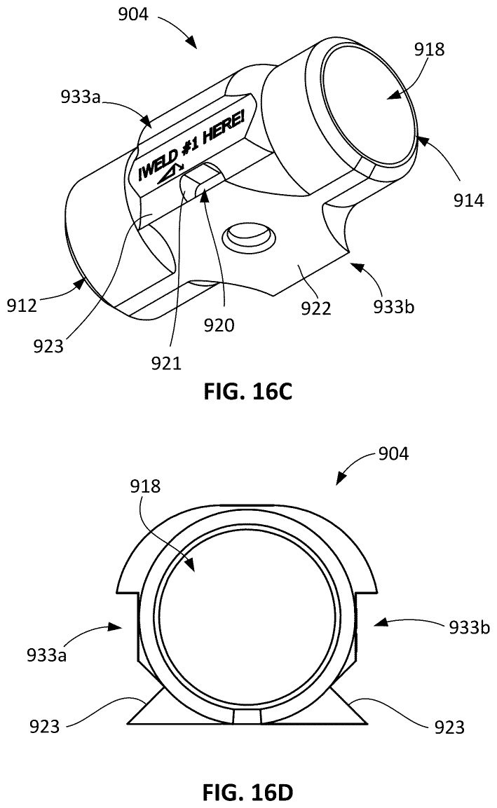

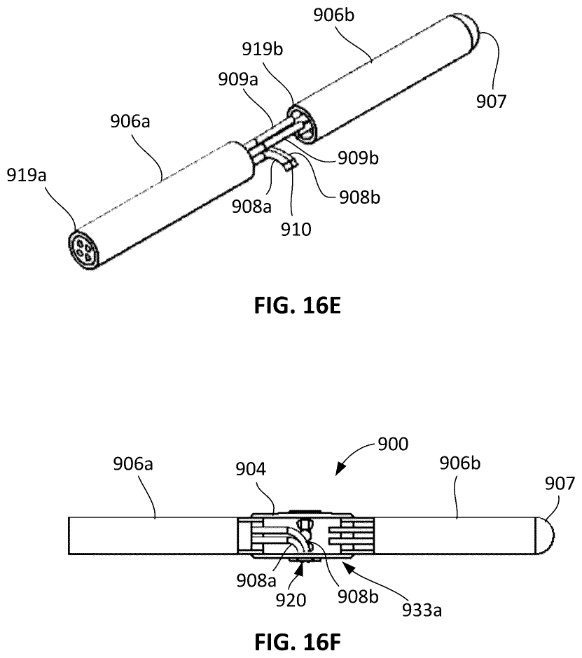

FIG. 16A is perspective view of a thermocouple sensor system 900 according to yet another embodiment. The sensor system 900 includes a thermocouple sensor 901 including a sensor block 904 having first and second end 912 and 914, and opposite sides 933a and 933b between the first and second ends 912 and 914. The system 900 further includes an additional sensor 907 coupled to the thermocouple sensor 901.

FIGS. 16B to 16D illustrate the sensor block 904 of the system 900 in FIG. 16A. The sensor block 904 in this embodiment defines a first passage 918 (FIG. 16B) therethrough from the first end 912 to the second end 914. A section of cable 906 may be received in the first passage 918 through the first and second ends 912 and 914. That is, a first cable section 906a extends into the first end 912 and a second cable section 906b extends into the second end 914. As will be described in more detail below, the cable 906 comprises a first pair of conductive wires 908a and 908b (FIGS. 16E and 16F) that extends into the sensor block (with the first cable section 906a) and forms a thermocouple junction 910 (FIG. 16F) within the sensor block 904. The cable 906 also comprises a second pair of conductive wires that extends through the sensor block 904, through both the first and second cable sections 906a and 906b. In this example, the second cable section 906b is connected to an additional sensor 907. The second pair of conductive wires that extends through the sensor block 904 may be from the same MI Cable or spliced to a new cable. That is, the first and second cable sections 906a and 906b may be from the same original continuous cable, or may be two separate sections spliced together.

The second passage 920 in this embodiment extends from the first passage 918 to the side 933a, near the bottom face 922. Opening 921 to the second passage defined by the outer surface of the sensor block 904 is shown in FIGS. 16B and 16C.

FIG. 16E is a perspective view of the sensor system 900 of FIG. 16A, with the sensor block 904 removed. A first pair of the wires 908a and 908b extends from the first cable section 906a into the second passage 920 (see FIG. 16C) of the sensor block 904. The first pair of the wires 908a and 908b form a thermocouple junction 910 at their terminal ends. The junction 110 may be positioned at least partially within the second passage 920. The junction 910 may extend at least partially from the second passage 920. A second pair of wires 909a and 909b continues from the first cable section and through the second cable section 906b to the additional sensor 907.

FIG. 16F is a top cutaway view of the sensor 900, where a top portion of the sensor block 904 is cutaway to show the first pair of wires 908a and 908b that extend into the second passage 920.

The junction 910 formed of two wires 908a and 908b is positioned at the side 933a of the sensor block 904. The sensor system 900 may be configured as a multipoint boiler tube block (BTB) sensor. The additional sensor 907 may be a grounded thermocouple sensor. Rather than additional sensor 907, the second cable section 906b may connect to another BTB block or weld pad. This block configuration allows the transition splice for the continued sensor as well as the junction to be made at the block. This may be done for adding one or more additional sensors to the system 900. In still other embodiments, additional pairs of wires may be included, and a series of blocks 904 may be connected cable sections to form a series of thermocouple sensors.

The sensor block 904 also includes beveled weld preparation sections 923 along its sides 933a and 933b, adjacent to the bottom face 922 of the sensor block 904. The sensor block 904 may, for example, be welded to a pipe (e.g. similar to the pipes 102, 302 etc. shown in the drawings and discussed above) by welding along the weld preparation regions. Welding the weld preparation region 923 on the first side 933a may also weld the junction together with the metal of the sensor block 904 and the pipe.

In other embodiments, the sensor block may form an elbow bend, with the first passage through the sensor block exiting at an angle relative to the entrance angle. As another example, more than two openings for receiving more than two cable sections may be provided. For example, the sensor block may form a four-way (X) junction with four openings to receive four cable sections. Other arrangements are also possible.

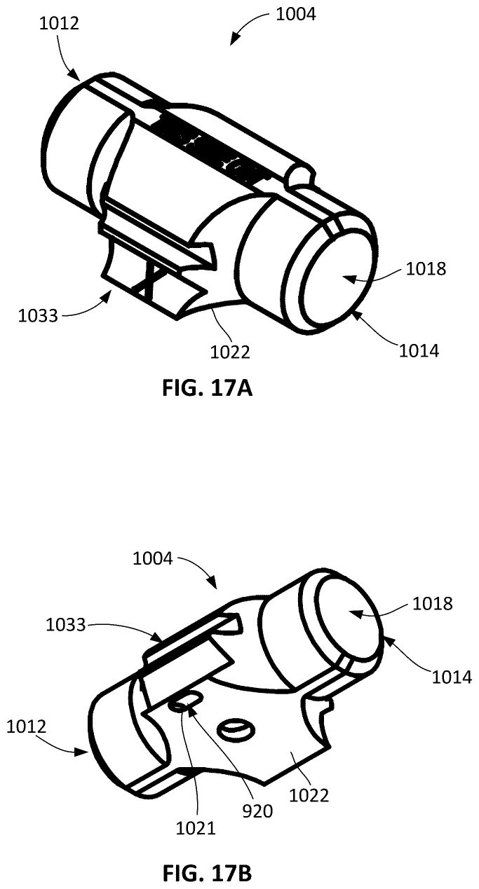

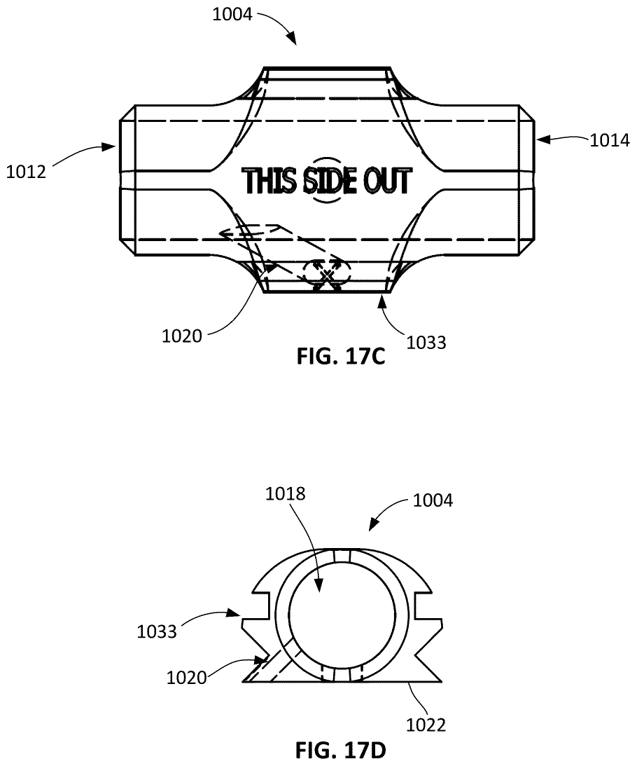

FIGS. 17A to 17D illustrate yet another example sensor block 1004 according to some embodiments. The sensor block 1004 may be used in the system 900 of FIG. 16A rather than the sensor block 904, for example. The sensor block 1004 is similar to the sensor block 904 of FIGS. 16A to 16D and includes a first passage 1018 extending therethrough from the first end 1012 to the second end 1014. In this embodiment, however, the second passage 1020 of the sensor block 1004 extends from the inner passage 1018 to an opening 1021 located on the bottom face 1022, proximate to a side 1033 of the sensor block 1004.

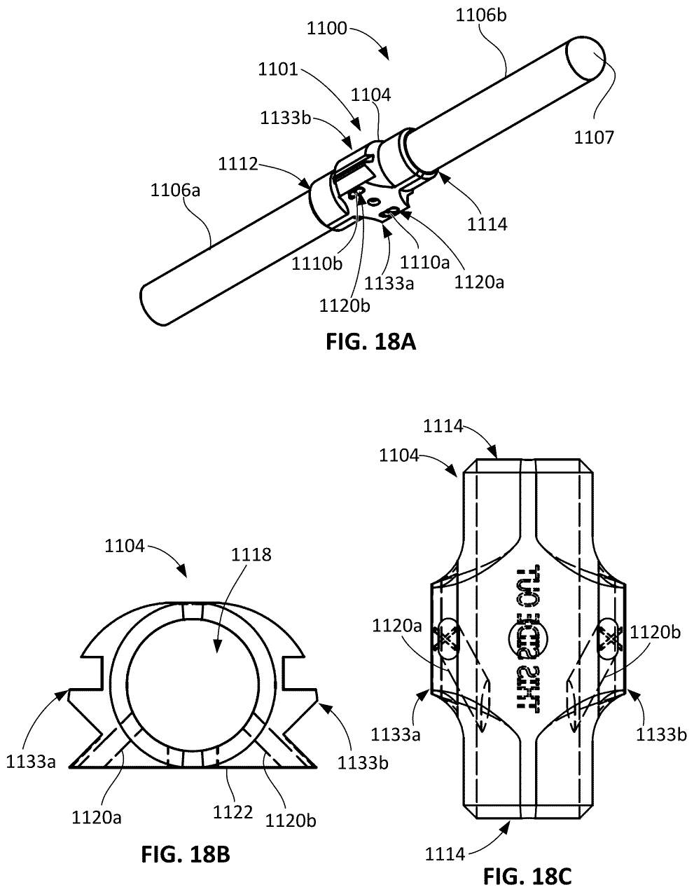

FIG. 18A is a perspective view of yet another thermocouple sensor system 1100 according to some embodiments. Similar to the example of FIG. 16A, The sensor system 1100 includes a thermocouple sensor 1101 including a sensor block 1104 having first and second end 1112 and 1114, and opposite sides 1133a and 1133b between the first and second ends 1112 and 1114. The system 1100 further includes an additional sensor 1107 coupled to the thermocouple sensor 1101. The sensor block 1104 in this embodiment defines a first passage 1118 (FIG. 18B) therethrough from the first end 1112 to the second end 1114. A section of cable 1106 may be received in the first passage 1118 through the first and second ends 1112 and 1114. That is, a first cable section 1106a extends into the first end 1112 and a second cable section 1106b extends into the second end 1114. The first and second cable sections 1106a and 1106b may be from the same original continuous cable, or may be two separate sections spliced together.

FIGS. 18B and 18C are end and top view of the sensor block 1104 in isolation. In this embodiment, the sensor block 1104 includes two passages 1120a and 1120b extending from the inner passage 1118 to the bottom face 1122 of the sensor block (near the sides 1133a and 1133b), similar to the example of FIGS. 11A to 11E. The first cable section 1106a contains six conductive wires (three pairs) as will be discussed in more detail below. Two of the pairs form thermocouple junctions in the sensor block 1104 and a third pair passes uninterrupted through the junction block 1104 to the additional sensor 1107. Additional one or more pairs of wires may also continue through the sensor block 1104 to other equipment. The sensor block 1104 may be wired in a string with one or more similar sensor blocks 1104 and/or one or more other sensor blocks, for example.

In other embodiments, a sensor block for multiple thermocouple junctions may form an elbow bend, with the first passage through the sensor block exiting at an angle relative to the entrance angle. As another example, more than two openings for receiving more than two cable sections may be provided. For example, the sensor block may form a four-way (X) junction with four openings to receive four cable sections. Other arrangements are also possible. The locations of the openings of the passages for thermocouple junctions may be positioned in any location(s) on the sensor block where measurement points are desired.

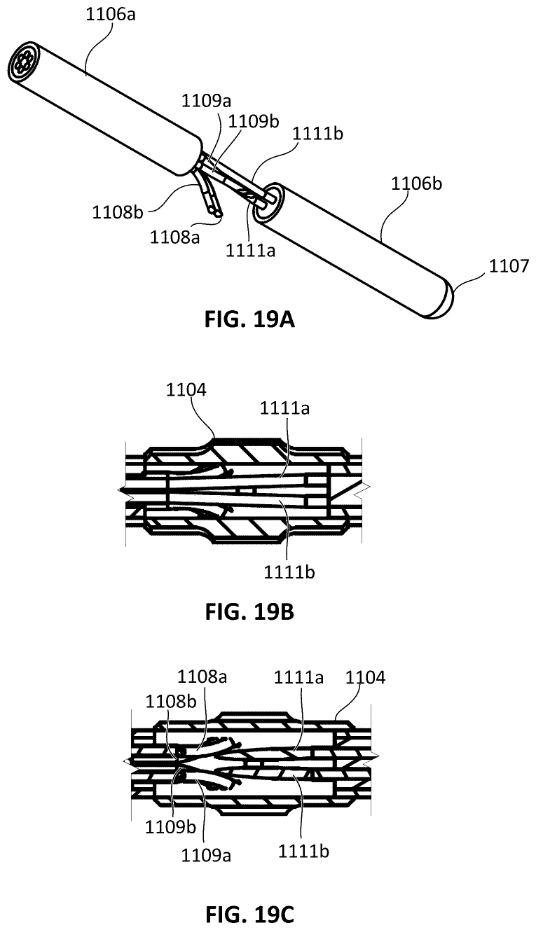

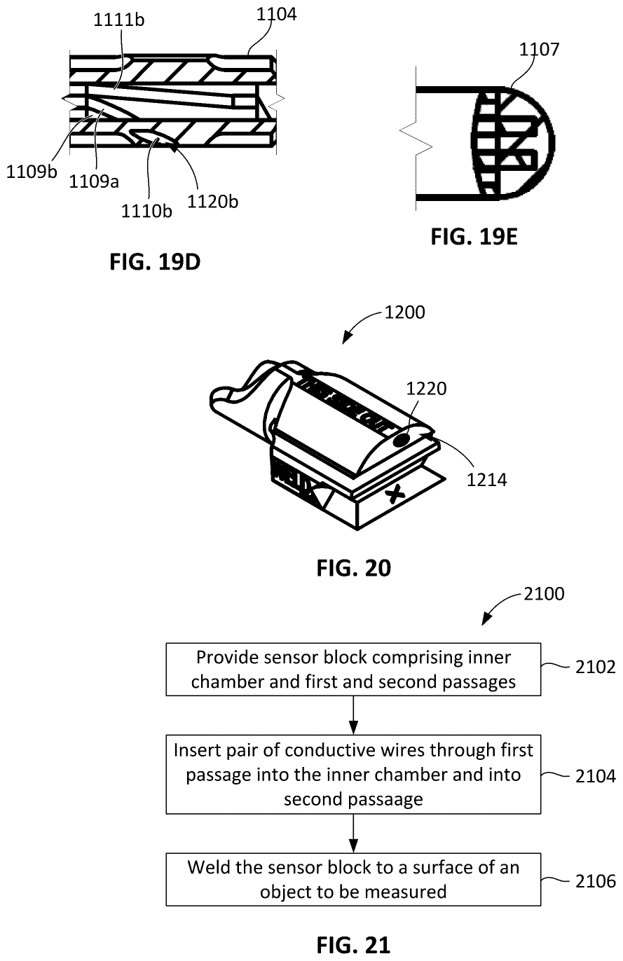

FIG. 19A is a perspective view of the cable sections 1106a and 1106b and six conductive wires (1108a, 1108b, 1109a, 1109b, 1111a, 1111b) of the cable sections 1106a and 1106b, with the sensor block 1104 removed.

A first pair of the wires 1108a and 1108b extends from the first cable section 1106a into the passage 1120a (see FIG. 18A) of the sensor block 1104, and end portions of the first pair of wires 1108a/1108b are coupled to form a first thermocouple junction 1110a. The junction 1110a may extend at least partially out from the passage 1120a (i.e. at least partially exposed). A second pair of the wires 1109a and 1109b extends from the first cable section 1106a into the passage 1120b (see FIG. 18A) of the sensor block 1104, and end portions of the first pair of wires 1109a/1109b are coupled to form a second thermocouple junction 1110b. The junction 1110a may extend at least partially out from the passage 1120a (i.e. at least partially exposed). The junctions 1110a and 1110b may be welded to seal the passages 1120a and 1120b. The junctions 1110a and 1110b are welded over when the sensor block 1104 is installed to a pipe or other object to be measured. A third pair of wires 1111a and 1111b may continue uninterrupted from the first cable section and through the second cable section 1106b to the additional sensor 1107. The first and second cable sections 1106a and 1106b may be formed from one continuous cable, or the first and second cable sections 1106a and 1106b may be separate sections spliced together. For example, the third pair of wires 1111a and 1111b extending from the first cable section 1106a may be spliced to a corresponding pair of wires in the second cable section 1106b.

FIG. 19B is a top cross-sectional, partial view of the sensor 1101 showing the sensor block 1104 and the third pair of wires 1111a and 1111b that continues to the additional sensor 1107 (FIG. 19A).

FIG. 19C is a top cross-sectional, partial view of the sensor 1101. This cross section is taken at a lower elevation than FIG. 19B, so that the first and second pairs of wires (1108a/1108b, 1109a/1109b) are better shown.

FIG. 19D is a side cross-sectional, partial view of the sensor 1101 showing the sensor block 1104 with the second pair of wires 1109a/1109b forming a junction 1110b in the passage 1120b. Wire 1111b is also visible.

FIG. 19E is a top cross-sectional view of the additional sensor 1107. The additional sensor in this example may be an ungrounded or grounded thermocouple sensor. Rather than additional sensor 1107, the second cable section 1106b may connect to another BTB block or weld pad. This block configuration allows the transition splice for the continued sensor as well as the junction to be made at the block. This may be done for adding one or more additional sensors to the system 1100. In still other embodiments, additional pairs of wires may be included, and a series of blocks 904 may be connected with cable sections to form a series of thermocouple sensors. The number of sensors connected in a string may only limited by the number of conductors that the cable can functionally hold.

The sensor blocks described herein may have a QR code directly on the sensor that may be scanned by a user to obtain installation instructions and/or other instructions. Markings or text may be provided directly on the sensor block to indicate installation instructions or guidance.

The thermocouple sensors described herein may beneficially be quality checked with Liquid penetrant inspection (LPI), X-Ray, and/or hydrotesting.

The passage(s) to hold junction(s) formed by a pair of conductive wires may extend to openings at various points on the sensor block (top face, bottom face, sides, end, etc.). For example, one or more junctions may be located on sides(s), top, and/or bottom of the sensor block. As another example, the sensor block and pairs of wires forming junctions may form junctions at: each side of the block, the bottom of the block, and/or the top of the block. The multiple junctions may allow for measuring multiple elements such as an object on which the sensor is mounted, and one or more fluids to which the sensor is exposed (e.g., gas temperature, oil temperature, etc.).

FIG. 20 is a perspective view of another sensor block 1200 according to some embodiments. The sensor block 1200 is similar to the sensor block 304 in FIG. 9A to 9E, but the sensor block 1200 in this example has a second passage 1220 that extends to the second end 1214, above the weld preparation region 1223 and near the top 1215 of the sensor block 1200. The junction(s) in some embodiments may be anywhere on the outside of the block to be able to line up with the measurement locations.

The dimension of the sensor blocks described herein may vary and may depend on various implementation specific factors, such as cable and conductive wire size, the surface curvature material of the pipe (or other tubular) or other object to be measured, measurement environment factors, and more. In some embodiments, for example, the sensor block may be between 0.5 and 1 inch long, approximately 0.5 inches wide, and less than 0.5 inches tall. However, embodiments are not limited to any particular dimensions of the sensor block, or to a particular size of the cable or conductive wires forming the junction.

The sensors described herein may provide a number of benefits over prior sensor designs, potentially including one or more of the following benefits. The sensors described herein may require less welding of the sensor block than prior existing surface-embedded sensors. The “hot junction” of the sensors described herein may be exposed or near the sides/end of the sensor block, which may provide greater access to the junction when welding (per the markings on the block). As noted above, some sensor blocks described herein include a strain relief feature to facilitate bending of the cable, which may allow both radial and axial installation and cable orientation relative to the sensor block.

The sensor blocks described herein may be is fully seal welded during installation, using metal to seal instead of ceramic cement which may extends the sensor's longevity in harsh process condition environments.

The sensor designs described herein, in some embodiments, may be smaller and/or use smaller conductive wires for the junction than prior sensors, and may have improved its response time. As also noted above, when the junction extends to the bottom face of the sensor bloc, the junction may beneficially be in contact with the surface to be measured (e.g. pipe surface) before welding is started.

In embodiments with two or more thermocouple junction locations, the sensor may beneficially include multiple independent (isolated) measuring locations. This is in contrast to designs in which multiple pairs of wires may be welded together in a common junction at a single location, which may still provide beneficial redundancy in the case of failure of one pair of wires (but a single measurement location).

The sensors described herein may have a robust welding design to be able to easily weld it directly onto the surface being measured without damaging the thermocouple wires leading to failure of the sensor junction (opening the circuit). This direct welding may allow for faster response times, and stronger mounting points. Prior multi-point sensors may use brackets, or mounts, rather than direct welding. However, such mounts may not have good surface contact (i.e. poor contact resistance).

FIG. 21 is a flowchart of an example method 2100 according to some embodiments. At block 2102, a sensor block is provided. The sensor block has first and second ends and defining an inner chamber and comprising: a first passage extending from the first end of the sensor block to the inner chamber; and a second passage extending from the inner chamber to an outer surface of the sensor block. The sensor block may have the form of any of the sensor blocks described herein, such as the blocks 104, 204, 304, 404, 504, 604, 1004, 1104, or 1200 shown in the drawings and described above. Providing the sensor block may comprise making, manufacturing, purchasing, or otherwise obtaining the sensor block.

At block 2104, a pair of conductive wires is inserted through the first passage into the inner chamber of the sensor block and into second passage from the inner chamber, the pair of conductive wires being coupled together to form a thermocouple junction. The pair of conductive wires may be part of a cable having a sheath. The sheath may be received into the first passage, as described herein. The first passage may have an opening and the sheath may be welded to the opening, for example.

The method may further include forming the thermocouple junction by welding end portions of the pair of conductive wires together.

The method may further include placing an insulating material in the inner chamber through an opening in the sensor block. The method may include sealing the opening after placing the insulating material in the inner chamber.

The sensor block and the conductive wires together form a thermocouple sensor, and the method may comprise welding the sensor to a surface to be measured. Thus, optionally at block 2106, the method further includes welding the sensor block and thermocouple junction to a surface of an object to be measured. The object to be measured may be a pipe or other tube, for example.

The method may further include obtaining one or more temperature measurements using the sensor.

The method 2100 of FIG. 21 may be performed in combination with the features of any one or more embodiments described above including those embodiments shown in FIGS. 1 to 20.

It is to be understood that a combination of more than one of the approaches described above may be implemented. Embodiments are not limited to any particular one or more of the approaches, methods, apparatuses or features disclosed herein. One skilled in the art will appreciate that variations, alterations of the embodiments described herein may be made in various implementations without departing from the scope of the claims.

1. A thermocouple sensor comprising:
a sensor block having first and second ends, the sensor block defining an inner chamber and comprising:
a first passage extending from the first end of the sensor block to the inner chamber; and
a second passage extending from the inner chamber to an outer surface of the sensor block; and
a pair of conductive wires extending through the first passage into the inner chamber of the sensor block and extending into second passage from the inner chamber, the pair of conductive wires being coupled together to form a thermocouple junction.

2. The thermocouple sensor of claim 1, wherein the junction formed by the pair of conductive wires extends at least partially out from the second passage.

3. The thermocouple sensor of claim 1, wherein the second passage extends from the inner chamber to a passage opening defined in the outer surface of the sensor block, wherein the passage opening is located at or proximate to the second end of the sensor block.

4. The thermocouple sensor of claim 1, wherein the second passage extends from the inner chamber to a passage opening defined in the outer surface of the sensor block, wherein the passage opening is located at or proximate to a side the sensor block.

5. The thermocouple sensor of claim 1, wherein the sensor block has a bottom face for mounting on an object, and the passage opening is positioned in the bottom face of the sensor block.

6. The thermocouple sensor of claim 3, wherein second passage extends, from the inner chamber and to the passage opening, at a downward angle and toward the second end.

7. The thermocouple sensor of claim 1, wherein the second passage extends from the inner chamber to the second end of the sensor block.

8. The thermocouple sensor of claim 1, comprising a cable, the cable comprising a cable sheath, at least the first and second conductive wires, and insulating material surrounding the conductive wires within the sheath, the first and second conductive wires having end portions extending from the sheath and insulating material, wherein the end portions of the first and second conductive wires are coupled to form the thermocouple junction.

9. The thermocouple sensor of claim 8, wherein the cable sheath is received into the first passage, and the end portions of the first and second conductive wires extend into the second passage.

10. The thermocouple sensor of claim 1, wherein the pair of conductive wires is a first pair of conductive wires, and the junction is a first junction, the thermocouple sensor further comprising:
a third passage extending from the inner chamber to the outer surface of the sensor block; and
a second pair of conductive wires extending into the sensor block through the first passage and into the third passage, the pair of wires forming a second thermocouple junction at least partially within the third passage.

11. The thermocouple sensor of claim 8, wherein the sensor block has a bottom face, and the second and third passages extend from an inner surface of the inner chamber to second and third openings, respectively, at the bottom face of the sensor block.

12. The thermocouple sensor of claim 11, wherein second and third passages extend, from the inner chamber and to the passage opening, at a downward angle and toward the second end.

13. The thermocouple sensor of claim 12, wherein the second and third passages extend, from the inner chamber, toward opposite respective sides of the sensor block.

14. The thermocouple sensor of claim 1, wherein the sensor block comprises a weld preparation region extending along a portion of the periphery of the sensor block adjacent the bottom face.

15. The thermocouple sensor of claim 14, wherein the weld preparation comprises a tapered surface, the passage opening being located at least partially within or under the tapered surface.

16. The thermocouple sensor of claim 1, wherein the sensor block defines one or more downward facing shoulders on at least one of the second end and first and second sides of the sensor block, and the thermocouple sensor further comprises a heatshield covering the sensor block.

17. The thermocouple sensor of claim 1, wherein the first passage extends from the first end to the second end, the first passage defining the inner chamber.

18. The thermocouple sensor of claim 17, further comprising a cable extending through the first passage and comprising first and second pairs of conductive wires, the cable comprising the pair of conductive wires extending into the second passage and forming the thermocouple junction, the cable further comprising a second pair of conductive wires that extend through the first passage and out from the first passage at the second end of the sensor block.

19. A sensor block for a thermocouple sensor, the sensor block having first and second ends and defining an inner chamber, the sensor block comprising:
a first passage extending from the first end of the sensor block to the inner chamber; and
a second passage extending from the inner chamber to an outer surface of the sensor block and shaped to receive a pair of conductive wires forming a thermocouple junction at least partially within the second passage.

20. The sensor block of claim 19, wherein the second passage extends from the inner chamber to a passage opening defined in the outer surface of the sensor block, wherein the passage opening is located at or proximate to the second end of the sensor block.

21. The sensor block of claim 19, wherein the sensor block has a bottom face for mounting on an object, and the passage opening is positioned in the bottom face of the sensor block.

22. The sensor block of claim 19, wherein the first passage is shaped to receive a cable comprising the pair of conductive wires.

23. The sensor block of claim 19, further comprising a third passage extending from the inner chamber to the outer surface of the sensor block and shaped to receive a second pair of conductive wires forming a second thermocouple junction at least partially within the second passage.

24. A method comprising:
providing a sensor block, the sensor block having first and second ends and defining an inner chamber and comprising: a first passage extending from the first end of the sensor block to the inner chamber; and a second passage extending from the inner chamber to an outer surface of the sensor block; and
inserting a pair of conductive wires through the first passage into the inner chamber of the sensor block and into second passage from the inner chamber, the pair of conductive wires being coupled together to form a thermocouple junction.

25. The method of claim 24, further comprising welding the sensor block and thermocouple junction to a surface of an object to be measured.
